(19) United States
(12) Patent Application Publication
(10) Pub. No.: US 2013/0255800 A1
(43) Pub. Date: Oct. 3, 2013

(54) OXYGEN ALARM SYSTEM

(71) Applicant: Jared MOORE, Newport News, VA (US)

(72) Inventor: Jared MOORE, Newport News, VA (US)

(21) Appl. No.: 13/438,728

(22) Filed: Apr. 3, 2012

(51) Int. Cl. F16K 37/00; F16K 31/36

(52) U.S. Cl. 137/505.11; 137/551

(57) ABSTRACT

The present invention is a metal oxygen alarm system that indicates to a user when an oxygen tank is at a predetermined low level that includes an alarm valve that emits a whistle sound that is audible in an ordinary decibel level environment activated when the oxygen tank is at the predetermined low oxygen pressure level and a portable oxygen regulator that has a top inlet and a bottom inlet and is attached to the oxygen tank and regulates an amount of oxygen provided to the user.

### TECHNICAL FIELD & BACKGROUND

Some people use a tank to carry oxygen for medical purposes. If the tank runs out of gas and a refill source is unavailable, it can be detrimental to a person's health.

The present invention generally relates to an alarm system. More specifically, the invention is an oxygen alarm system.

It is an object of the invention to provide an oxygen alarm system that indicates to a user when an oxygen tank is at a predetermined low level.

It is an object of the invention to provide an oxygen alarm system that allows an alarm valve that can be attached to a bottom portion or a top portion of a portable oxygen regulator.

It is an object of the invention to provide an oxygen alarm system that provides an alarm sound that is audible in a relatively ordinary or a relatively loud decibel level environment.

What is really needed is an oxygen alarm system that indicates to a user when an oxygen tank is at a predetermined low level that allows an alarm valve that can be attached to a bottom portion or a top portion of a portable oxygen regulator that provides an alarm sound that is audible in a relatively ordinary or a relatively loud decibel level environment.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of an oxygen alarm system, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

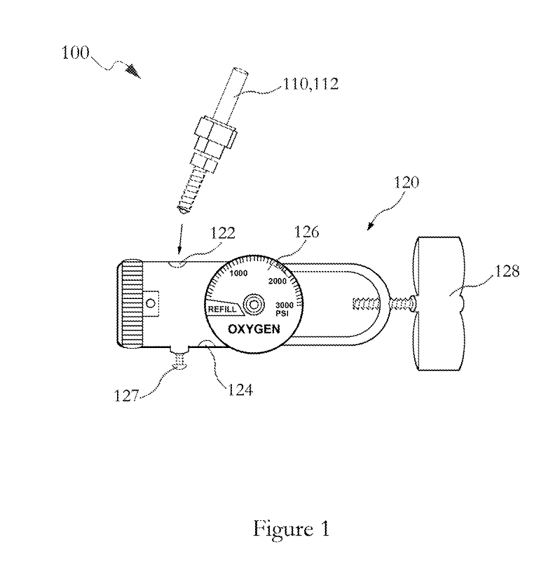

FIG. 1 illustrates a front view of an oxygen alarm system 100, according to an embodiment of the present invention.

The oxygen alarm system 100 includes an alarm valve 110 and a portable oxygen regulator 120. The alarm valve 110 is a relatively low pressure alarm valve 112 that emits a whistle sound that is audible in a relatively ordinary or a relatively loud decibel level environment when activated but can emit any other suitable sound such as a horn sound or a beeping sound. The alarm valve 110 is activated when an oxygen tank (not shown) is at a predetermined low oxygen pressure level. The predetermined low oxygen pressure level can be any suitable predetermined low oxygen pressure level desired by a user. The alarm valve 110 is fastened to the oxygen tank through a relatively tiny aperture (not shown) disposed on the oxygen tank. The portable oxygen regulator 120 has a top inlet 122 and a bottom inlet 124 and is attached to an oxygen tank or other suitable gaseous substance tank and regulates an amount of oxygen provided to a user. The portable oxygen regulator 120 also includes a pressure gauge 126, a pressure relief valve 127 and a screw handle 128. The alarm valve 110 can be inserted into the top inlet 122 or the bottom inlet 124 of the portable oxygen regulator 120 providing added flexibility and convenience in utilizing a traditional portable oxygen regulator 120.

The oxygen alarm system indicates to a user when an oxygen tank is at a predetermined low level that allows an alarm valve that can be attached to a bottom portion or a top portion of a portable oxygen regulator that provides an alarm sound that is audible in a relatively ordinary or a relatively loud decibel level environment.

The oxygen alarm system is an auditory attachment for breathing oxygen or other suitable gas tanks. The oxygen alarm system is made of metal and has a relatively small, screw-like shape that relatively quickly and easily attaches to an oxygen regulator. The oxygen alarm system has a low pressure valve, which is fastened to an oxygen tank through a relatively tiny aperture. When the pressure typically expressed in pounds per square inch or PSI in the oxygen tank drops below a pre-determined level, the oxygen alarm system will emit a whistle sound to alert the user to refill the oxygen tank. The oxygen alarm system may be readily available for purchase at retail stores where medical supplies are sold. The oxygen alarm system features a small, low pressure valve attached to an oxygen tank gas tank typically utilized to assist the user with breathing. The oxygen alarm system is designed to release an audible sound when pressure in the oxygen tank reaches a pre-determined level.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An oxygen alarm system that indicates to a user when an oxygen tank is at a predetermined low level, comprising:
an alarm valve that emits a whistle sound that is audible in an ordinary decibel level environment activated when said oxygen tank is at said predetermined low oxygen pressure level; and
a portable oxygen regulator that has a top inlet and a bottom inlet and is attached to said oxygen tank and regulates an amount of oxygen provided to said user.

2. The system according to claim 1, wherein said alarm valve emits a horn sound.

3. The system according to claim 1, wherein said alarm valve emits a beeping sound.

4. The system according to claim 1, wherein said alarm valve is audible in a loud decibel level environment.

5. The system according to claim 1, wherein said portable oxygen regulator includes a pressure gauge.

6. The system according to claim 1, wherein said portable oxygen regulator includes a screw handle.

7. The system according to claim 1, wherein said alarm valve is inserted into said top inlet.

8. The system according to claim 1, wherein said alarm valve is inserted into said bottom inlet.

9. The system according to claim 1, wherein said alarm valve is inserted into said top inlet or said bottom inlet of said portable oxygen regulator providing added flexibility and convenience to said user.

10. The system according to claim 1, wherein said portable oxygen regulator includes a pressure relief valve.

11. A metal oxygen alarm system that indicates to a user when an oxygen tank is at a predetermined low level, comprising:
an alarm valve that emits a whistle sound that is audible in an ordinary decibel level environment activated when said oxygen tank is at said predetermined low oxygen pressure level; and
a portable oxygen regulator that has a top inlet and a bottom inlet and is attached to said oxygen tank and regulates an amount of oxygen provided to said user.

12. The system according to claim 11, wherein said alarm valve emits a horn sound.

13. The system according to claim 11, wherein said alarm valve emits a beeping sound.

14. The system according to claim 11, wherein said alarm valve is audible in a loud decibel level environment.

15. The system according to claim 11, wherein said portable oxygen regulator includes a pressure gauge.

16. The system according to claim 11, wherein said portable oxygen regulator includes a screw handle.

17. The system according to claim 11, wherein said alarm valve is inserted into said top inlet.

18. The system according to claim 11, wherein said alarm valve is inserted into said bottom inlet.

19. The system according to claim 11, wherein said alarm valve is inserted into said top inlet or said bottom inlet of said portable oxygen regulator providing added flexibility and convenience to said user.

20. The system according to claim 11, wherein said portable oxygen regulator includes a pressure relief valve.
